(19) United States
(12) Patent Application Publication
(10) Pub. No.: US 2010/0104895 A1
(43) Pub. Date: Apr. 29, 2010

(54) STRUCTURE OF A FUEL CELL STACK

(75) Inventors: Hsi-Ming Hsu, Taipei City (TW); Tsang-Ming Chang, Taipei City (TW); Ming-Huang Tsai, Taipei City (TW); Chia-Hao Chang, Taipei City (TW); Ting-Yi Yu, Taipei City (TW); Wei-Li Huang, Taipei City (TW)

Correspondence Address: APEX JURIS, PLLC, 12733 LAKE CITY WAY NORTHEAST, SEATTLE, WA, 98125, US

(73) Assignee: ANTIG TECHNOLOGY CORPORATION, Grand Cayman (GB)

(21) Appl. No.: 12/261,029

(22) Filed: Oct. 29, 2008

(51) Int. Cl. H01M 8/00

(52) U.S. Cl. 429/12

(57) ABSTRACT

A structure of a fuel cell stack is disclosed, comprising: a first cathode plate, a first fuel cell module, a first anode channel plate, a second fuel cell module, a cathode channel plate, a third fuel cell module, a second anode channel plate, a fourth fuel cell module, and a second cathode plate stacked from top to bottom. The fuel cell stack of the invention can be assembled easily.

### FIELD OF THE INVENTION

The invention relates to a structure of a fuel cell stack, and more particularly to a structure of a fuel cell stack that may be easily assembled.

### BACKGROUND OF THE INVENTION

In the U.S. Patent publication No. US20,060,051,626A1 with the title of “Fuel Cell Stack” published earlier, a structure of a fuel cell stack has already been disclosed; whereas other types of fuel cell stack structure have also been disclosed in U.S. Patent publication No. US20,050,074,652A1 with the title of “Direct Liquid Feed Fuel Cell Stack”, as well as in U.S. Patent publication No. US20,050,042,493A1 titled “Fuel Cell Device”. It can be the that the aforesaid three types of fuel cell stack structure have facilitated better understanding about the fuel cell stacks for developers thereof.

However, in light of disadvantages found in conventional structures of the fuel cell stack, the inventor of the present invention has proposed a structure of a fuel cell stack that may be easily assembled.

### SUMMARY OF THE INVENTION

A primary objective of the invention is to propose a structure of a fuel cell stack that may be easily assembled.

To achieve the aforesaid objective, a structure of a fuel cell stack disclosed in the invention comprises: a first cathode plate, a first fuel cell module, a first anode channel plate, a second fuel cell module, a cathode channel plate, a third fuel cell module, a second anode channel plate, a fourth fuel cell module, and a second cathode plate stacked from top to bottom; wherein the cathode channel plate has fuel inlet and outlet disposed thereon, and the first fuel cell module, the second fuel cell module, the third fuel cell module, and the fourth fuel cell module are structurally identical; each of the fuel cell modules respectively includes: a cathode current collector plate, at least more than one membrane electrode assembly, an adhesive strip having at least one receiving space for separately receiving the membrane electrode assemblies, a positioning plate having at least more than one receiving space, at least more than one current collector sheet being respectively disposed in the receiving spaces of the positioning plate; wherein the cathode current collector plate and the positioning plate are held together by using the adhesive strip, and the membrane electrode assemblies are sandwiched between the cathode current collector plate and the positioning plate; the first cathode plate and the second cathode plate are structurally identical, while the first anode channel plate and the second anode channel plate are structurally identical.

### BRIEF DESCRIPTION OF DRAWINGS

The structure, feature, and performance of the present invention can be best understood by referring to the following detailed description of the preferred embodiments and the accompanying drawings, wherein:

FIG. 1 is a schematic view that shows a fuel cell stack made up of structures from FIGS. 2A to 2D according to a first embodiment of the present invention;

FIG. 2A is a disassembled view that shows a first portion of a fuel cell stack according to the first embodiment of the present invention;

FIG. 2B is a disassembled view that shows a second portion of a fuel cell stack according to the first embodiment of the present invention;

FIG. 2C is a disassembled view that shows a third portion of a fuel cell stack according to the first embodiment of the present invention;

FIG. 2D is a disassembled view that shows a fourth portion of a fuel cell stack according to the first embodiment of the present invention;

FIG. 3 is a schematic view that shows an assembled fuel cell stack according to the first embodiment of the present invention;

FIG. 4 is a schematic view that shows a fuel cell stack in combination with a first mask and a first fan according to the first embodiment of the present invention;

FIG. 5 is a schematic view that shows a fuel cell stack in combination with a second mask and a second fan according to the first embodiment of the present invention;

FIG. 6 is a schematic view that shows a fuel cell stack made up of structures from FIGS. 7A to 7D according to a second embodiment of the present invention;

FIG. 7A is a disassembled view that shows a first portion of a fuel cell stack according to the second embodiment of the present invention;

FIG. 7B is a disassembled view that shows a second portion of a fuel cell stack according to the second embodiment of the present invention;

FIG. 7C is a disassembled view that shows a third portion of a fuel cell stack according to the second embodiment of the present invention;

FIG. 7D is a disassembled view that shows a fourth portion of a fuel cell stack according to the second embodiment of the present invention;

FIG. 8 is a schematic view that shows an assembled fuel cell stack according to the second embodiment of the present invention;

FIG. 9 is a schematic view that shows a fuel cell stack in combination with the first mask and the first fan according to the second embodiment of the present invention; and

FIG. 10 is a schematic view that shows a fuel cell stack in combination with the second mask and the second fan according to the second embodiment of the present invention.

### DETAILED DESCRIPTION OF THE INVENTION

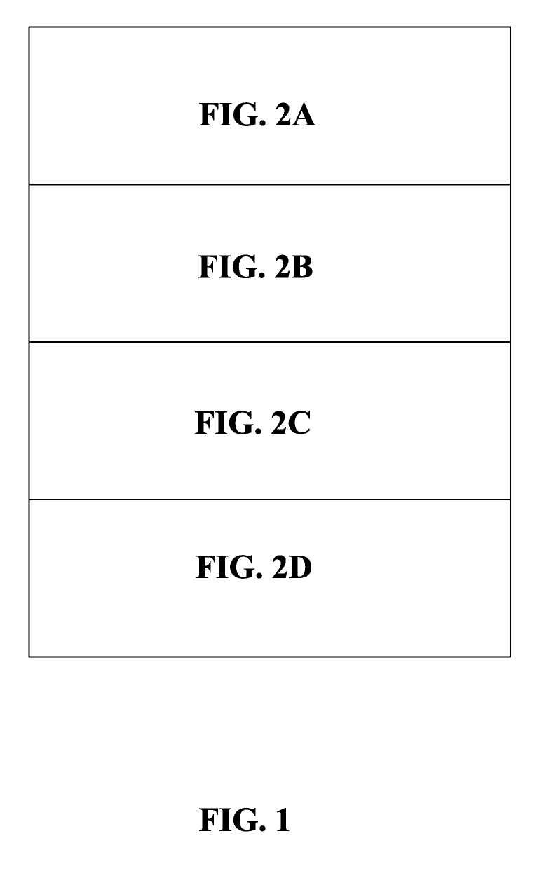

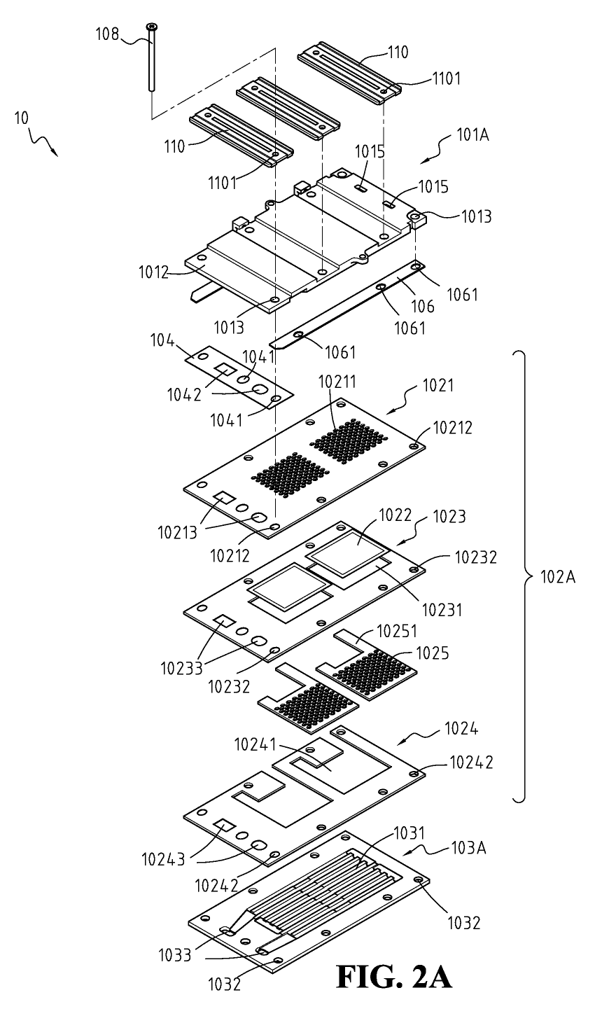

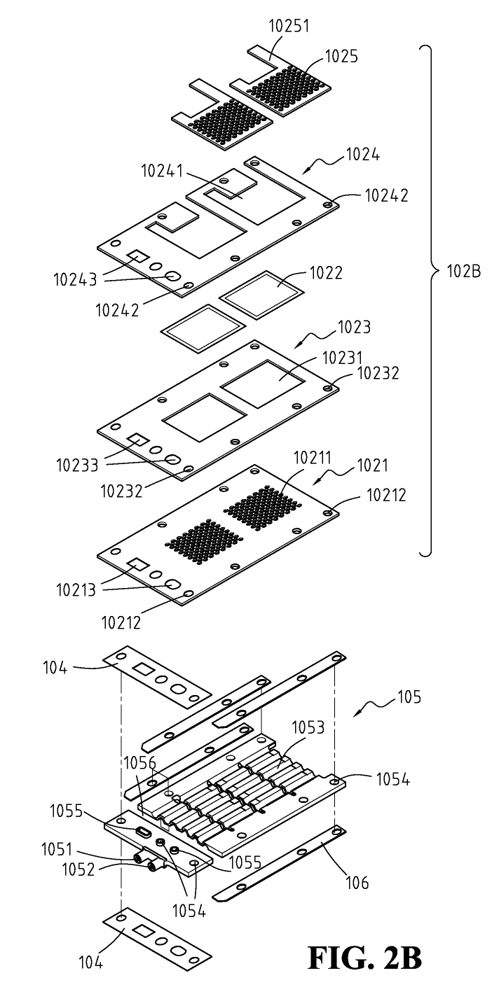

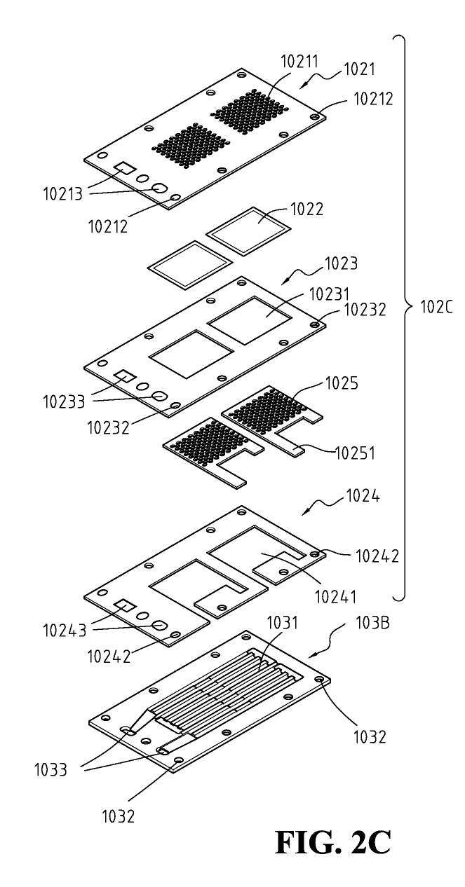

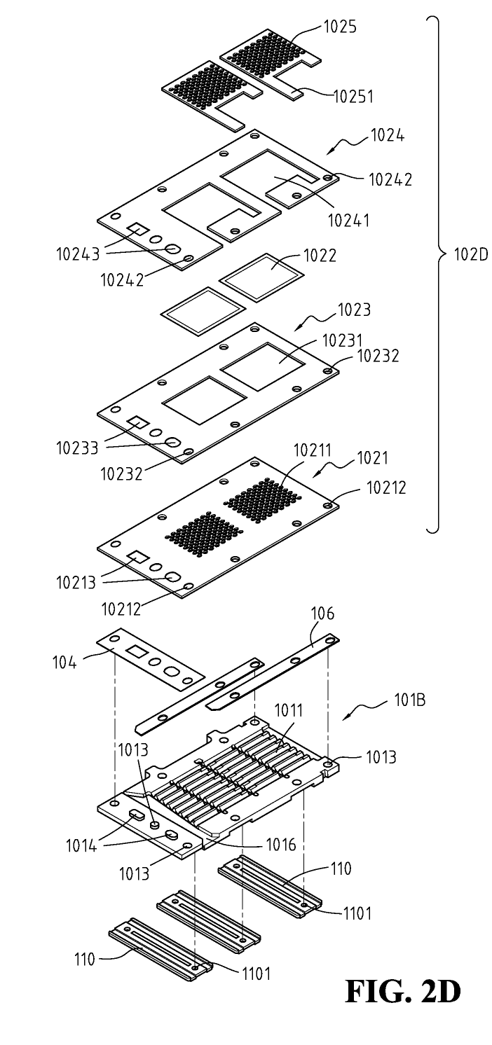

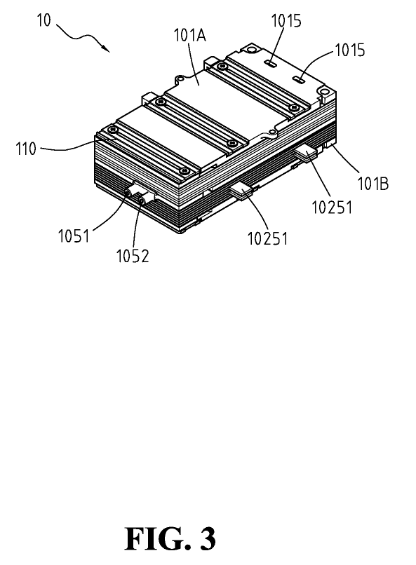

FIG. 1 is a schematic view that shows a fuel cell stack made up of structures from FIGS. 2A to 2D according to a first embodiment of the present invention; FIG. 2A is a disassembled view that shows a first portion of a fuel cell stack according to the first embodiment of the present invention; FIG. 2B is a disassembled view that shows a second portion of a fuel cell stack according to the first embodiment of the present invention; FIG. 2C is a disassembled view that shows a third portion of a fuel cell stack according to the first embodiment of the present invention; FIG. 2D is a disassembled view that shows a fourth portion of a fuel cell stack according to the first embodiment of the present invention; while FIG. 3 is a schematic view that shows an assembled fuel cell stack according to the first embodiment of the present invention. According to a first embodiment of the invention, a fuel cell stack 10 is mainly comprised of a first cathode plate 101A, a first fuel cell module 102A, a first anode channel plate 103A, a second fuel cell module 102B, a cathode channel plate 105, a third fuel cell module 102C, a second anode channel plate 103B, a fourth fuel cell module 102D, and a second cathode plate 101B stacked from top to bottom. A plurality of first pads 104, a plurality of second pads 106, and a plurality of bearing plates 110 are respectively disposed in correspondence with the first cathode channel plate 107A, the first cathode plate 103A, and the second cathode plate 103B, which are described in further details hereafter respectively.

The first fuel cell module 102A, the second fuel cell module 102B, the third fuel cell module 102C, and the fourth fuel cell module 102D are structurally identical, and each of the fuel cell modules 102A, 102B, 102C, and 102D respectively comprises: a cathode current collector plate 1021, at least more than one membrane electrode assembly 1022, an adhesive strip 1023, a positioning plate 1024, and at least more than one current collector sheet 1025.

The cathode current collector plate 1021 has a plurality of through openings 10211 disposed thereon, as well as screw holes 10212 and openings 10213 peripherally disposed thereon. The through openings 10211 are used to allow cathode fuels and cathode products to pass through. The cathode current collector plate 1021 may be made from materials including one of resistant and non-conductive engineering plastic substrates, carbon-reinforced plastic substrates, FR4 substrates, FR5 substrates, epoxy resin substrates, fiber glass substrates, ceramic substrates, polymer plastic substrates, composite substrates, and printed circuit boards.

The embodiment of the membrane electrode assemblies 1022 may be implemented by using prior arts of this field. For example, a direct methanol membrane electrode assemblies made of proton exchange membranes may be used.

The adhesive strip 1023 has at least one receiving space 10231 for respectively receiving the membrane electrode assemblies 1022. In addition, the adhesive strip 1023 also has screw holes 10232 and openings 10233 peripherally disposed thereon, and may be made of PP adhesives.

The positioning plate 1024 has at least one receiving space 10241 for receiving the current collector sheet 1025. The positioning plate 1024 also has screw holes 10242 and openings 10243 peripherally disposed thereon, and may be made from materials including one of resistant and non-conductive engineering plastic substrates, carbon-reinforced plastic substrates, FR4 substrates, FR5 substrates, epoxy resin substrates, fiber glass substrates, ceramic substrates, polymer plastic substrates, composite substrates, and printed circuit boards.

The current collector sheet 1025 may include an outwardly-extending sheet 10251 disposed thereon, and the sheet 10251 mainly serves as a point of electrical connection in either serial-connections or parallel-connections of the membrane electrode assemblies 1022. The current collector sheet 1025 includes a plurality of openings disposed thereon, and the openings are used to allow anode fuels and anode products to pass through. The current collector sheet 1025 may be made from conductive materials, and is preferably made from resistant materials that have anti-corrosive and/or anti-acidic properties. For instance, the materials may be one of stainless steel sheets (SUS316), gold foils, titanium, graphite, carbon-metal compounds, metal alloys, and polymer conductive pads with low electrical resistance.

The cathode channel plate 105 further includes a anode fuel inlet 1051 and a anode fuel outlet 1052 disposed thereon. The anode fuel inlet 1051 and the anode fuel outlet 1052 respectively serves as a sole entry/exit for anode fuels for the fuel cell stack 10 according to the first embodiment of the invention. The cathode channel plate 105 is a dual-surface cathode channel plate, which includes two opposing surfaces having channels 1053, respectively. Moreover, a groove 1056 is disposed between the channels 1053 and the anode fuel inlet 1051, as well as the anode fuel outlet 1052. The cathode channel plate 105 has screw holes 1054 and openings 1055 peripherally disposed thereon, and may be made from materials including one of resistant and non-conductive engineering plastic substrates, carbon-reinforced plastic substrates, FR4 substrates, FR5 substrates, epoxy resin substrates, fiber glass substrates, ceramic substrates, polymer plastic substrates, composite substrates, and printed circuit boards.

The first anode channel plate 103A and the second anode channel plate 103B are structurally identical, which are both dual-surface anode channel plates and include two opposing surfaces having channels 1031, respectively. The first anode channel plate 103A and the second anode channel plate 103B have screw holes 1032 and openings 1033 peripherally disposed thereon. In addition, the first anode channel plate 103A and the second anode channel plate 103B may be made from materials including one of resistant and non-conductive engineering plastic substrates, carbon-reinforced plastic substrates, FR4 substrates, FR5 substrates, epoxy resin substrates, fiber glass substrates, ceramic substrates, polymer plastic substrates, composite substrates, and printed circuit boards.

The first cathode plate 101A and the second cathode plate 101B are structurally identical, which are both single-surface cathode plates having channels 1011 disposed on internal surfaces thereof, and at least one recess 1012 disposed on external surfaces thereof. Both the first cathode plate 101A and the second cathode plate 101B include screw holes 1013, protruding caps 1014, and recessed holes 1015 peripherally disposed thereon. The caved grooves 1016 are disposed between the channels 1011 and the screw holes 1013, as well as the protruding caps 1014. The first cathode plate 101A and the second cathode plate 101B may be made from materials including one of resistant and non-conductive engineering plastic substrates, carbon-reinforced plastic substrates, FR4 substrates, FR5 substrates, epoxy resin substrates, fiber glass substrates, ceramic substrates, polymer plastic substrates, composite substrates, and printed circuit boards.

Each of the first pads 104 has at least three screw holes 1041 and two openings 1042 disposed thereon; the screw holes 1041 and the openings 1042 correspond to the screw holes 1054 and the openings 1055 of the cathode channel plate 105, and also to the screw holes 1013 and the protruding caps 1014 of the first and the second cathode plates 101A, 101B.

Each of the second pads 106 has at least three screw holes 1061 disposed thereon, and the screw holes 1061 correspond to the screw holes 1054 of the cathode channel plate 105, and to the screw holes 1013 of the first and the second cathode plates 101A, 101B as well.

The first pads 104 and the second pads 106 may be made of rubber.

Each of the bearing plates 110 has at least two screw holes 1101 disposed thereon, and the screw holes 1101 correspond to the screw holes 1013 of the first and the second cathode plates 101A, 101B. The bearing plates 110 may be made of hard metals.

With regard to assembling the fuel cell stack 10 according to the first embodiment of the invention; firstly dispose two pieces of the first pads 104 and four pieces of the second pads 106 onto the two opposing external surfaces of the cathode channel plate 105, respectively, and then separately stack two pieces of the cathode current collector plate 1021 onto the external surfaces of the cathode channel plate 105, such that the first pads 104 and the second pads 106 are sandwiched between the cathode channel plate 105 and the cathode current collector plate 1021. Afterwards, two pieces of the adhesive strip 1023 are allowed to adhere to the external surfaces of the two cathode current collector plates 1021, and then four pieces of the membrane electrode assemblies 1022 are respectively disposed into the two receiving spaces 10231 of the two adhesive strips 1023, such that the membrane electrode assemblies 1022 come into contact with the two cathode current collector plates 1021. This is followed by allowing tow pieces of the positioning plates 1024 to adhere to the external surfaces of the two adhesive strips 1023, then four pieces of the current collector sheets 1025 are respectively disposed into the receiving spaces 10241 of the two positioning plates 1024, such that each of the current collector sheets 1025 comes into contact with an anode and a cathode from each of the four membrane electrode assemblies 1022 respectively, thereby forming anode and cathode current collector sheets 1025; while the sheets 10251 of the current collector sheets 1025 are allowed to extend out of the two positioning plates 1024.

Subsequently, two pieces of the first and the second anode channel plates 103A and 103B are respectively disposed onto the external surfaces of the two positioning plates 1024 and the four current collector sheets 1025, so that the second fuel cell module 102B and the third fuel cell module 102C are sandwiched between the cathode channel plate 105 and the first and second anode channel plates 103A and 103B. In the following step, another two pieces of the positioning plates 1024 are disposed to the external surfaces of the first and second anode channel plates 103A and 103B, and then another four pieces of the current collector sheets 1025 are respectively disposed into the receiving spaces 10241 of the two positioning plates 1024. Similarly, the sheets 10251 of the current collector sheets 1025 are also allowed to extend out of the two positioning plates 1024.

Subsequently, adhere another two pieces of the adhesive strips 1023 onto the external surfaces of the two positioning plates 1024, so as to sandwich the four current collector sheets 1025 between the positioning plates 1024 and the adhesive strips 1023; while the four membrane electrode assemblies 1022 are respectively disposed into the two receiving spaces 10231 of the two adhesive strips 1023, so that each of the current collector sheets 1025 comes into contact with an anode and a cathode from each of the four membrane electrode assemblies 1022, thereby forming anode and cathode current collector sheets 1025. Next, another two pieces of the cathode current collector plates 1021 are allowed to adhere to the external surfaces of the two adhesive strips 1023 and the four membrane electrode assemblies 1022, followed by separately disposing one piece of the first pad 104 and two pieces of the second pad 106 to the internal surfaces of the first cathode plate 101A and the second cathode plate 101B, while three pieces of the bearing plates 110 are disposed to the recesses 1012 on the external surfaces of the first and second cathode plates 101A and 101B, respectively. Then the first and second cathode plates 101A and 101B are respectively disposed to the external surfaces of the two cathode current collector plates 1021, so that the first pad 104 and the second pads 106 are sandwiched between the first and second cathode plates 101A and 101B.

As a result, the first fuel cell module 102A and the fourth fuel cell module 102D are sandwiched between the first cathode plate 101A, the second cathode plate 101B, the first anode channel plate 103A, and the second anode channel plate 103B, thereby forming the fuel cell stack 10 according to the first embodiment of the invention. Finally, a plurality of screws 108 are inserted into the fuel cell stack 10, which go through the aforesaid components in the following order: the first cathode plate 101A, the first fuel cell module 102A, the first anode channel plate 103A, the second fuel cell module 102B, the cathode channel plate 105, the third fuel cell module 102C, the second anode channel plate 103B, the fourth fuel cell module 102D, and the second cathode plate 101B; as well as the screw holes of a plurality of the first pads 104, the second pads 106, and the bearing plates 110, thereby completing the assembly of the fuel cell stack 10 according to the first embodiment of the invention.

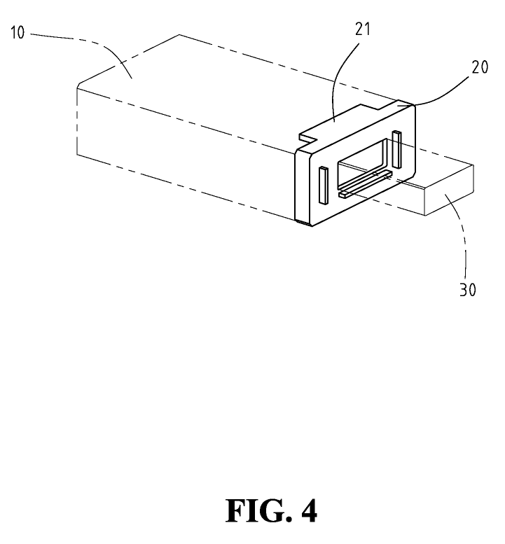

As shown in FIG. 4, a first mask 20 of the invention includes corresponding fastening portions 21 at two sides thereof, and the first mask 20 is fastened into recessed holes 1015 of the first cathode plate 101A and the second cathode plate 101B at two opposing sides of the fuel cell stack 10 by using the fastening portions 21, so as to combine the first mask 20 and the fuel cell stack 10 of the first embodiment together. Furthermore, a first fan 30 may also be combined with the first mask 20.

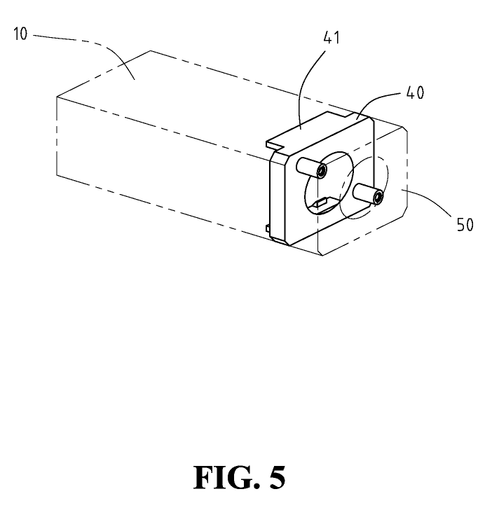

As shown in FIG. 5, a second mask 40 of the invention includes corresponding fastening portions 41 at two sides thereof, and the second mask 40 is fastened into recessed holes 1015 of the first cathode plate 101A and the second cathode plate 101B at two opposing sides of the fuel cell stack 10 by using the fastening portions 41, so as to combine the second mask 40 and the fuel cell stack 10 of the first embodiment together. Furthermore, a second fan 50 may also be combined with the second mask 40.

The first fan 30 and the second fan 50 may be selected from blowers and bladed fans, for instance. The fans are mainly used to provide propulsion required for allowing gases to flow, so as to allow external air and cathode products to flow within the fuel cell stack 10 of the first embodiment.

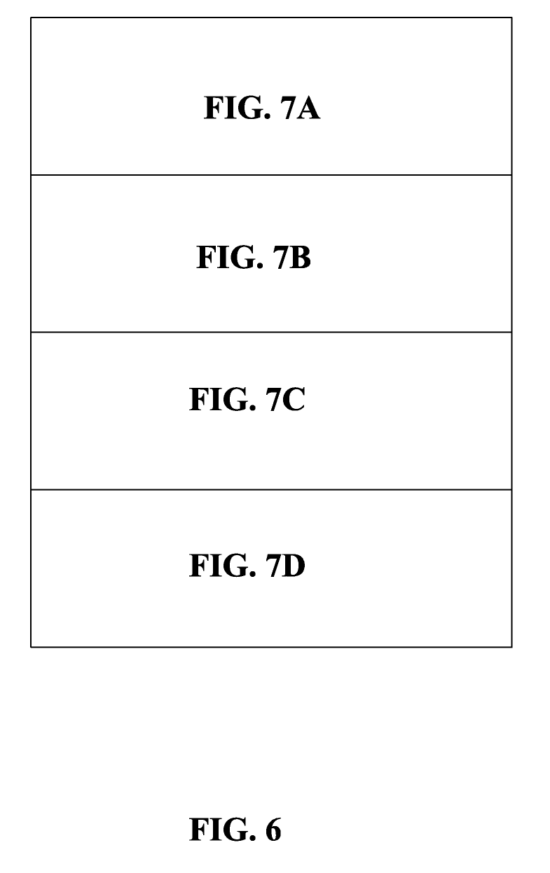

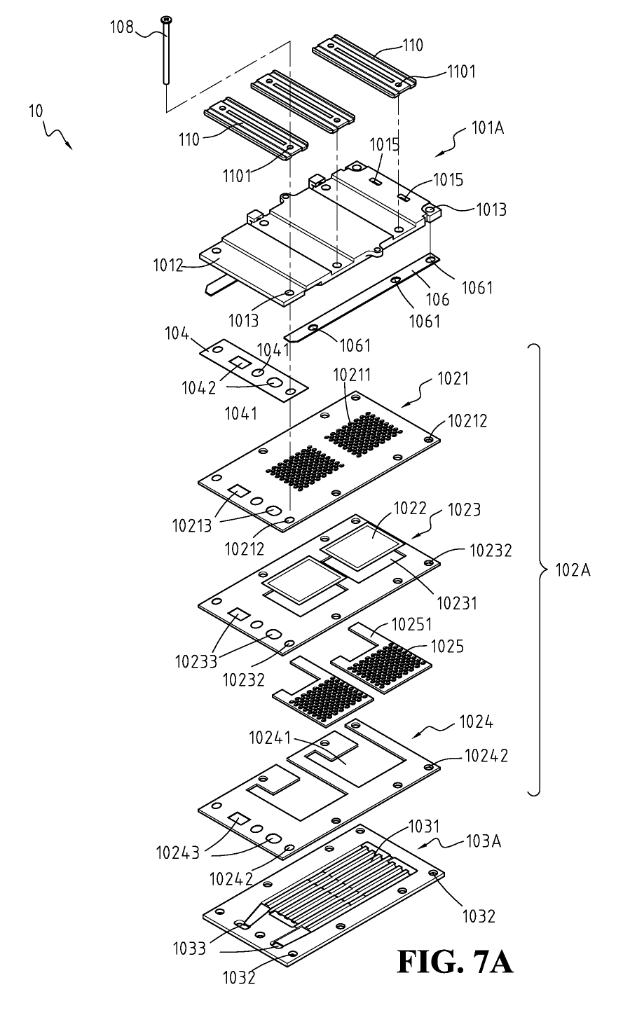

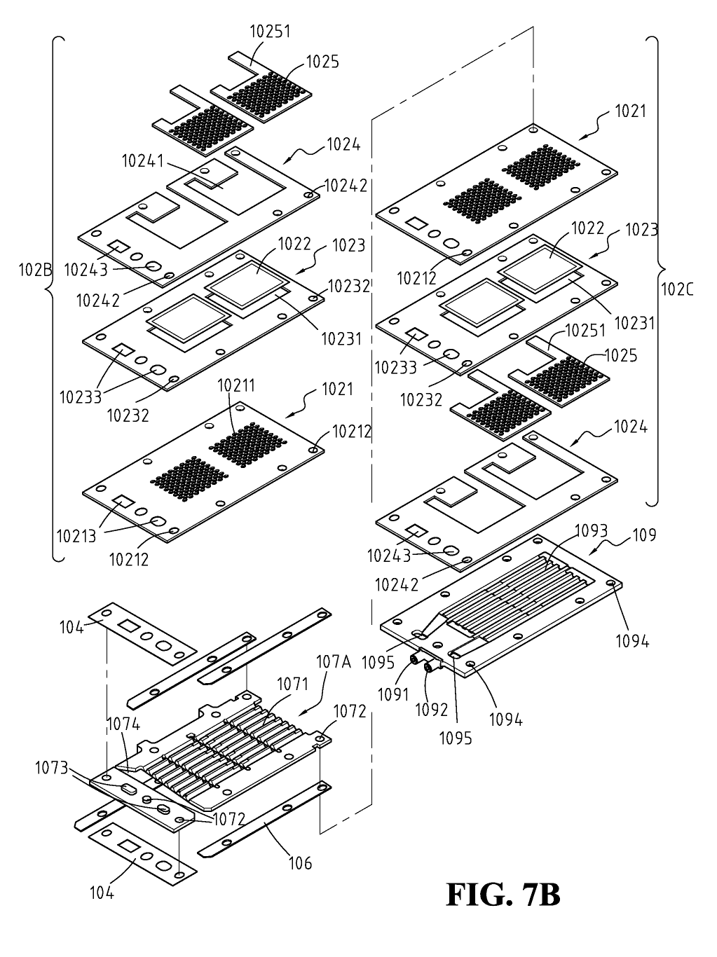

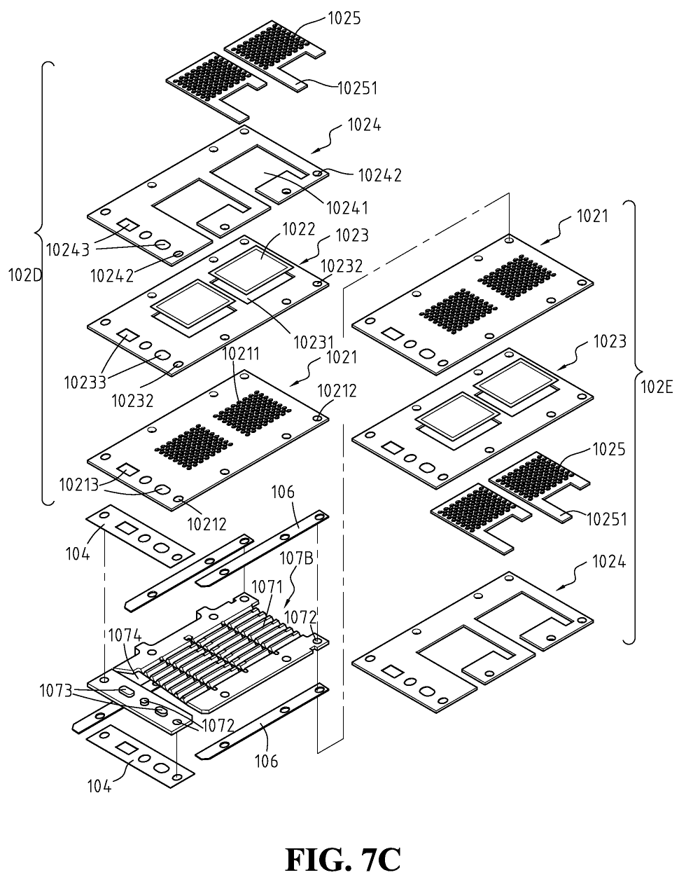

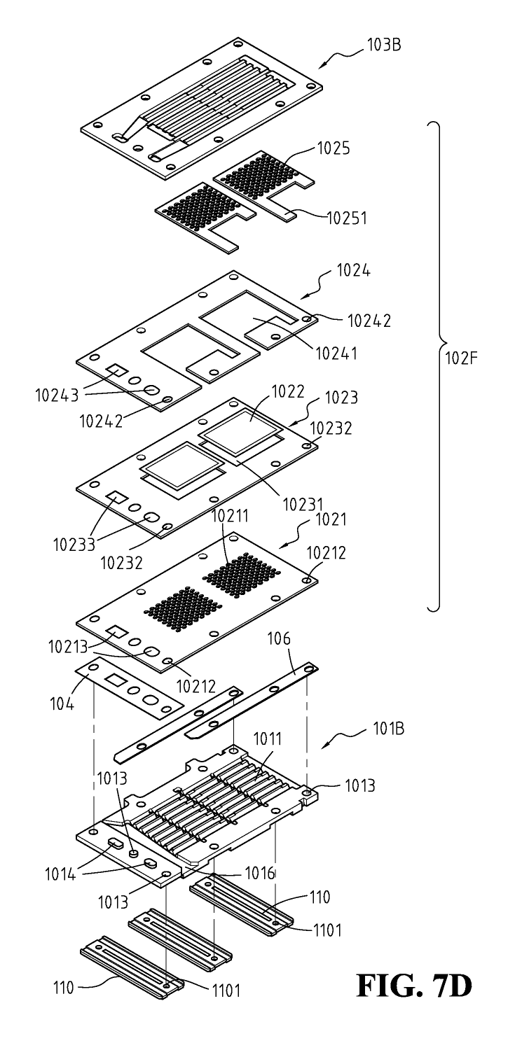

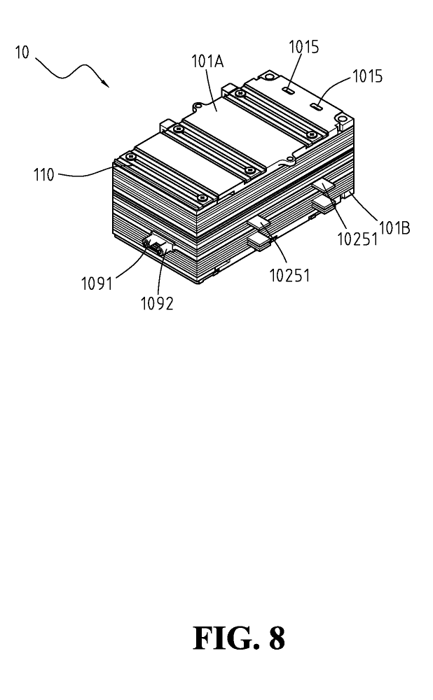

FIG. 6 is a schematic view that shows a fuel cell stack made up of structures from FIGS. 7A to 7D according to a second embodiment of the present invention; FIG. 7A is a disassembled view that shows a first portion of a fuel cell stack according to the second embodiment of the present invention; FIG. 7B is a disassembled view that shows a second portion of a fuel cell stack according to the second embodiment of the present invention; FIG. 7C is a disassembled view that shows a third portion of a fuel cell stack according to the second embodiment of the present invention; FIG. 7D is a disassembled view that shows a fourth portion of a fuel cell stack according to the second embodiment of the present invention, and FIG. 8 is a schematic view that shows an assembled fuel cell stack according to the second embodiment of the present invention. According to a second embodiment of the invention, a fuel cell stack 10 is primarily comprised of a first cathode plate 101A, a first fuel cell module 102A, a first anode channel plate 103A, a second fuel cell module 102B, a first cathode channel plate 107A, a third fuel cell module 102C, an anode channel plate 109, a fourth fuel cell module 102D, a second cathode channel plate 107B, a fifth fuel cell module 102E, a second anode channel plate 103B, a sixth fuel cell module 102F, and a second cathode plate 101B stacked from top to bottom. A plurality of first pads 104, a plurality of second pads 106, and a plurality of bearing plates 110 are respectively disposed in the first cathode channel plate 107A, the first cathode plate 103A, and the second cathode plate 103B, which are described in further details hereafter.

The first fuel cell module 102A, the second fuel cell module 102B, the third fuel cell module 102C, the fourth fuel cell module 102D, the fifth fuel cell module 102E, and the sixth fuel cell module 102F are structurally identical, and each of the fuel cell modules 102A, 102B, 102C, 102D, 102E, and 102F comprises: a cathode current collector plate 1021, at least more than one membrane electrode assembly 1022, an adhesive strip 1023, a positioning plate 1024, and at least more than one current collector sheet 1025. The fuel cell modules 102A, 102B, 102C, 102D, 102E, and 102F of the second embodiment are structurally identical to that of the first embodiment, thus will not be described again hereafter.

The anode channel plate 109 further includes an anode fuel inlet 1091 and an anode fuel outlet 1092 disposed thereon; wherein the anode fuel inlet 1091 and the anode fuel outlet 1092 respectively serves as a sole entry/exit for anode fuels for the fuel cell stack 10 according to the second embodiment of the invention. The anode channel plate 109 is a dual-surface anode channel plate, which includes two opposing surfaces having channels 1093, respectively. Moreover, the anode channel plate 109 has screw holes 1094 and openings 1095 peripherally disposed thereon, and may be made from materials including one of resistant and non-conductive engineering plastic substrates, carbon-reinforced plastic substrates, FR4 substrates, FR5 substrates, epoxy resin substrates, fiber glass substrates, ceramic substrates, polymer plastic substrates, composite substrates, and printed circuit boards.

The first anode channel plate 103A and the second anode channel plate 103B of the second embodiment are structurally identical, and both of which also share identical structures with the first and the second anode channel plates 103A and 103B of the first embodiment, thus will not be described again hereafter.

The first cathode channel plate 107A and the second cathode channel plate 107B are structurally identical, which are both dual-surface cathode channel plates and include two opposing surfaces having channels 1071, respectively. The first cathode channel plate 107A and the second cathode channel plate 107B have screw holes 1072 and openings 1073 peripherally disposed thereon. A U-shaped groove 1074 is disposed between the channels 1071 and the screw holes 1072, as well as the openings 1073. The first cathode channel plate 107A and the second cathode channel plate 107B may be made from materials including one of resistant and non-conductive engineering plastic substrates, carbon-reinforced plastic substrates, FR4 substrates, FR5 substrates, epoxy resin substrates, fiber glass substrates, ceramic substrates, polymer plastic substrates, composite substrates, and printed circuit boards.

The first cathode plate 101A and the second cathode plate 101B of the second embodiment are structurally identical, and both of which also share identical structures with the first and the second cathode plates 101A and 101B of the first embodiment, thus will not be described again hereafter.

The first pads 104, the second pads 106, and the bearing plates 110 used in the second embodiment are structurally identical to that of the first embodiment, thus will not be described again hereafter.

In regard to assembling the fuel cell stack 10 according to the second embodiment of the invention, two pieces of the positioning plates 1024 are respectively disposed to adhere to the two opposing external surfaces of the anode channel plate 109, and four pieces of the current collector sheets 1025 are respectively disposed into the receiving spaces 10241 of the two positioning plates 1024.

Subsequently, adhere two pieces of the adhesive strips 1023 onto the external surfaces of the two positioning plates 1024, such that the current collector sheets 1025 are sandwiched between the positioning plates 1024 and the adhesive strips 1023. Next, separately place four pieces of the membrane electrode assemblies 1022 into the two receiving spaces 10231 of the two adhesive strips 1023, such that each of the current collector sheets 1025 comes into contact with an anode and a cathode from each of the four membrane electrode assemblies 1022, thereby forming anode and cathode current collector sheets 1025; while the sheets 10251 of the current collector sheets 1025 are allowed to extend out of the two positioning plates 1024.

This is followed by adhering two pieces of the cathode current collector plates 1021 onto the external surfaces of the two adhesive strips 1023, so as to sandwich the four membrane electrode assemblies 1022 between the positioning plates 1024 and the adhesive strips 1023. Afterwards, two pieces of the first pads 104 and four pieces of the second pads 106 are respectively disposed to two opposing external surfaces of the first cathode channel plate 107A and the second cathode channel plate 107B. Then the first and second cathode channel plates 107A and 107B are disposed to the external surfaces of the two cathode current collector plates 1021.

As a result, the third fuel cell module 102C and the fourth fuel cell module 102D are sandwiched between the anode channel plate 109, the first cathode channel plate 107A, and the second cathode channel plate 107B. Consequently, allow another two pieces of the cathode current collector plates 1021 to dispose to the external surfaces of the first and second cathode channel plates 107A and 107B, such that the first pads 104 and the second pads 106 are sandwiched between the first cathode channel plate 107A and the two cathode current collector plates 1021. This is followed by adhering two pieces of the adhesive strips 1023 to the external surfaces of the two cathode current collector plates 1024, then respectively disposing four pieces of the membrane electrode assemblies 1022 into the two receiving spaces 10231 of the two adhesive strips 1023, such that the membrane electrode assemblies 1022 come into contact with the two cathode current collector plates 1021. Then two pieces of the positioning plates 1024 are disposed to the external surfaces of the two adhesive strips 1023, and four pieces of the current collector sheets 1025 are respectively disposed into the receiving spaces 10241 of the two positioning plates 1024, such that each of the current collector sheets 1025 comes into contact with an anode and a cathode from each of the four membrane electrode assemblies 1022, thereby forming anode and cathode current collector sheets 1025; while the sheets 10251 of the current collector sheets 1025 are allowed to extend out of the two positioning plates 1024.

Consequently, allow two pieces of the first anode channel plate 103A and the second anode channel plate 103B to respectively dispose to the external surfaces of the two positioning plates 1024 and the four current collector sheets 1025. As a result, the second fuel cell module 102B and the fifth fuel cell module 102E are sandwiched between the first cathode channel plate 107A, the second cathode channel plate 107B, the first anode channel plate 103A, and the second anode channel plate 103B. In the following step, another two pieces of the positioning plates 1024 are disposed to the external surfaces of the first and second anode channel plates 103A and 103B, and then another four pieces of the current collector sheets 1025 are respectively disposed into the receiving spaces 10241 of the two positioning plates 1024. Similarly, the sheets 10251 of the current collector sheets 1025 are also allowed to extend out of the two positioning plates 1024. Next, another two pieces of the adhesive strips 1023 are allowed to adhere to the external surfaces of the two positioning plates 1024, so as to sandwich the four current collector sheets 1025 between the positioning plate 1024 and the adhesive strip 1023. Afterwards, four pieces of the membrane electrode assemblies 1022 are respectively disposed into the two receiving spaces 10231 of the two adhesive strips 1023, such that each of the current collector sheets 1025 comes into contact with an anode and a cathode from each of the four membrane electrode assemblies 1022, thereby forming anode and cathode current collector sheets 1025.

Subsequently, another two pieces of the cathode current collector plates 1021 are disposed to the external surfaces of the two adhesive strips 1023 and the four membrane electrode assemblies 1022, and then another piece of the first pad 104 and two other pieces of the second pads 106 are respectively disposed to the internal surfaces of the first and second cathode plates 101A and 101B; while another three pieces of the bearing plates 110 are respectively disposed to the recesses 1012 on the external surfaces of the first and second cathode plates 101A and 101B. In addition, the first and second cathode plates 101A and 101B are respectively adhered to the external surfaces of the two cathode current collector plates 1021, such that the first and second pads 104 and 106 are sandwiched between the first and second cathode plates 101A and 101B. As a result, the first fuel cell module 102A and the sixth fuel cell module 102F are sandwiched between the first cathode plate 101A, the second cathode plate 101B, the first anode channel plate 103A, and the second anode channel plate 103B.

Finally, a plurality of screws 108 are inserted into the fuel cell stack 10, which go through the aforesaid components in the following order: the first cathode plate 101A, the first fuel cell module 102A, the first anode channel plate 103A, the second fuel cell module 102B, the first cathode channel plate 107A, the third fuel cell module 102C, the second anode channel plate 103B, the fourth fuel cell module 102D, and the second cathode plate 101B; as well as the screw holes of a plurality of the first pads 104, the second pads 106, and the bearing plates 110, thereby completing the assembly of the fuel cell stack 10 according to the second embodiment of the invention.

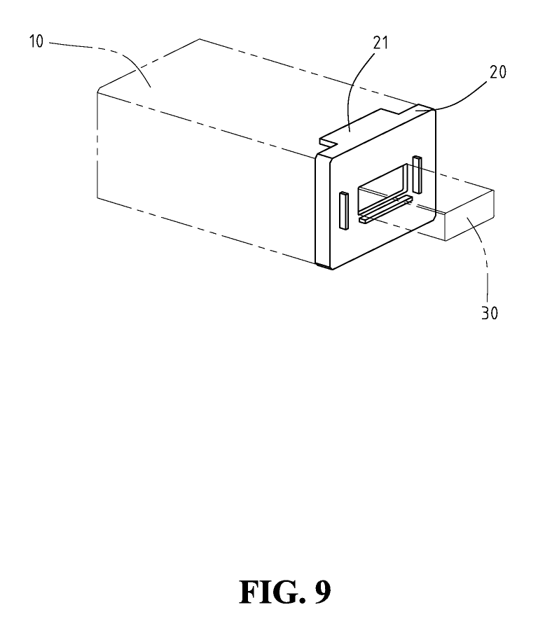

As shown in FIG. 9, the first mask 20 of the invention includes corresponding fastening portions 21 at two sides thereof, and the first mask 20 is fastened into recessed holes 1015 of the first cathode plate 101A and the second cathode plate 101B at two opposing sides of the fuel cell stack 10 by using the fastening portions 21, so as to combine the first mask 20 and the fuel cell stack 10 of the second embodiment together. Furthermore, the first fan 30 may also be combined with the first mask 20.

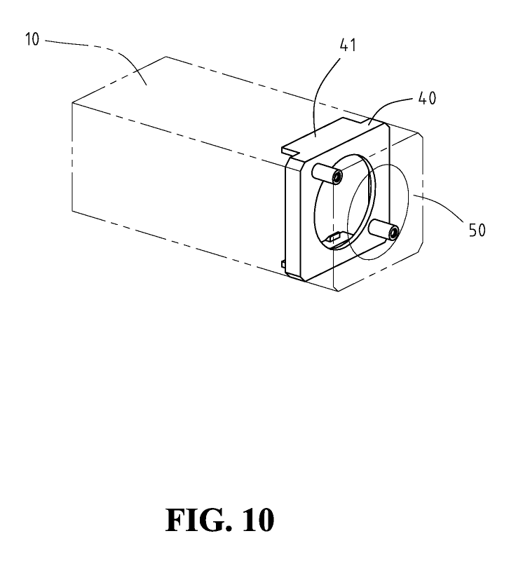

As shown in FIG. 10, the second mask 40 of the invention includes corresponding fastening portions 41 at two sides thereof, and the second mask 40 is fastened into recessed holes 1015 of the first cathode plate 101A and the second cathode plate 101B at two opposing sides of the fuel cell stack 10 by using the fastening portions 41, so as to combine the second mask 40 and the fuel cell stack 10 of the second embodiment together. Furthermore, the second fan 50 may also be combined with the second mask 40.

The first fan 30 and the second fan 50 may be selected from blowers and bladed fans, for instance. The fans are mainly used to provide propulsion required for allowing gases to flow, so as to allow external air and cathode products to flow within the fuel cell stack 10 of the second embodiment.

In the first and the second embodiments, the openings 1042, 10213, 10243, 1033, 10233, 1055, 1073, and 1095 serve as channels for anode fuels and anode products to pass through. The protruding caps 1014 are used to seal off the openings 1042 located on two outer-most sides of the fuel cell stack 10.

In the first and the second embodiments, the grooves 1016,1056, and 1074 are used to allow at least cathode fuels to pass through.

The fuel cell stacks 10 of the invention can be assembled easily, which is the main advantage and benefit of the present invention.

The aforesaid are merely preferred embodiments of the present invention and should not be used to restrict the scope of the present invention, and it is understood that those skilled in the art may carry out changes and modifications to the described embodiments without departing from the content of the invention.

What is claimed is:

1. A structure of a fuel cell stack; comprising: a first cathode plate (101A), a first fuel cell module (102A), a first anode channel plate (103A), a second fuel cell module (102B), a cathode channel plate (105), a third fuel cell module (102C), a second anode channel plate (103B), a fourth fuel cell module (102D), and a second cathode plate (101B) stacked from top to bottom;
wherein said first fuel cell module (102A), said second fuel cell module (102B), said third fuel cell module (102C), and said fourth fuel cell module (102D) are structurally identical, and each of the fuel cell modules (102A), (102B), (102C), and (102D) includes:
a cathode current collector plate (1021);
at least more than one membrane electrode assembly (1022);
an adhesive strip (1023) having at least one receiving space for respectively receiving said membrane electrode assemblies;
a positioning plate (1024) having at least more than one receiving space;
at least more than one current collector sheet (1025) being respectively disposed into said receiving spaces of said positioning plate;
wherein said cathode current collector plate (1021) and said positioning plate (1024) are held together by using said adhesive strip (1023), and said membrane electrode assemblies (1022) are sandwiched between said cathode current collector plate (1021) and said positioning plate (1024);
wherein said first cathode plate (101A) and said second cathode plate (101B) are structurally identical;
wherein said first anode channel plate (103A) and said second anode channel plate (103B) are structurally identical.

2. The fuel cell stack of claim 1, wherein the cathode current collector plates of said first fuel cell module, said second fuel cell module, said third fuel cell module, and said fourth fuel cell module are respectively disposed with a plurality of through openings.

3. The fuel cell stack of claim 1, wherein the cathode channel plate (105), the first anode channel plate (103A), and the second anode channel plate (103B) are respectively disposed with a plurality of corresponding openings and a plurality of corresponding screw holes; in which the first cathode plate (101A) and the second cathode plate (101B) are respectively disposed with a plurality of protruding caps and a plurality of screw holes.

4. The fuel cell stack of claim 1, wherein the cathode current collector plate (1021), the adhesive strip (1022), and the positioning plate (1024) are respectively disposed with a plurality of corresponding openings and a plurality of corresponding screw holes.

5. The fuel cell stack of claim 1, wherein the first cathode plate (101A) and the second cathode plate (101B) are respectively disposed with a plurality of recesses (1012) on external surfaces thereof.

6. The fuel cell stack of claim 1, further comprising: a plurality of first pads (104) and a plurality of second pads (106).

7. The fuel cell stack of claim 6, wherein the first pads (104) and the second pads (106) are made of rubber.

8. The fuel cell stack of claim 1, further comprising: a plurality of bearing plates (110).

9. The fuel cell stack of claim 8, wherein the bearing plates are made of hard metals.

10. The fuel cell stack of claim 1, wherein the adhesive strip (1023) is made of PP adhesives.

11. The fuel cell stack of claim 1, wherein the first cathode plate (101A), the second cathode plate (101B), the positioning plate (1024), the cathode channel plate (105), the first anode channel plate (103A), and the second anode channel plate (103B) may be made from materials including one of resistant and non-conductive engineering plastic substrates, carbon-reinforced plastic substrates, FR4 substrates, FR5 substrates, epoxy resin substrates, fiber glass substrates, ceramic substrates, polymer plastic substrates, composite substrates, and printed circuit boards.

12. The fuel cell stack of claim 1, wherein the current collector sheet (1025) may include an outwardly-extending sheet (10251) disposed thereon.

13. The fuel cell stack of claim 1, further comprising a first mask (20) for combining with a first fan (30).

14. The fuel cell stack of claim 1, further comprising a second mask (40) for combining with a second fan (50).

15. The fuel cell stack of claim 1, wherein the cathode channel plate (105) may include a cathode fuel inlet (1051) and a cathode fuel outlet (1052) disposed thereon.

16. A structure of a fuel cell stack; comprising: a first cathode plate (101A), a first fuel cell module (102A), a first anode channel plate (103A), a second fuel cell module (102B), a first cathode channel plate (107A), a third fuel cell module (102C), an anode channel plate (109), a fourth fuel cell module (102D), a second cathode channel plate (107B), a fifth fuel cell module (102E), a second anode channel plate (103B), a sixth fuel cell module (102F), and a second cathode plate (101B) stacked from top to bottom;
wherein said first fuel cell module (102A), said second fuel cell module (102B), said third fuel cell module (102C), said fourth fuel cell module (102D), said fifth fuel cell module (102E), and said sixth fuel cell module (102F) are structurally identical, and each of the fuel cell modules (102A), (102B), (102C), (102D), (102E), and (102F) respectively comprises:
a cathode current collector plate (1021);
at least more than one membrane electrode assembly (1022);
an adhesive strip (1023) having at least one receiving space for respectively receiving said membrane electrode assemblies;
a positioning plate (1024) having at least more than one receiving space;
at least more than one current collector sheet (1025) being respectively disposed into said receiving spaces of said positioning plate;
wherein said cathode current collector plate (1021) and said positioning plate (1024) are held together by using said adhesive strip (1023), and said membrane electrode assemblies (1022) are sandwiched between said cathode current collector plate (1021) and said positioning plate (1024);
wherein said first cathode plate (101A) and said second cathode plate (101B) are structurally identical;
wherein said first anode channel plate (103A) and said second anode channel plate (103B) are structurally identical;
wherein said first cathode channel plate (107A) and said second cathode channel plate (107B) are structurally identical.

17. The fuel cell stack of claim 16, further comprising a first mask (20) for combining with a first fan (30).

18. The fuel cell stack of claim 16, further comprising a second mask (40) for combining with a second fan (50).

19. The fuel cell stack of claim 16, wherein the anode channel plate (109) may include an anode fuel inlet (1091) and an anode fuel outlet (1092) disposed thereon.
